(19) United States
(12) Patent Application Publication
(10) Pub. No.: US 2004/0137278 A1
(43) Pub. Date: Jul. 15, 2004

(54) Perpendicular magnetic recording medium

(75) Inventors: Hiroyuki Uwazumi, Nagano (JP); Yasushi Sakai, Nagano (JP); Shunji Takenoiri, Nagano (JP)

Correspondence Address: ROSSI & ASSOCIATES, P.O. Box 826, Ashburn, VA, 20146-0826, US

(73) Assignee: Fuji Electric Co., Ltd.

(21) Appl. No.: 10/638,967

(22) Filed: Aug. 11, 2003

(30) Foreign Application Priority Data
Aug. 13, 2002 (JP) 2002-235777

(51) Int. Cl. G11B 5/66

(52) U.S. Cl. 428/694 TM; 428/694 R

(57) ABSTRACT

A perpendicular magnetic recording medium, which suppresses generation of spike noises, has a soft magnetic backing layer constructed of a laminated structure. The backing layer has at least one nonmagnetic metal layer at most 5 nm thick and at least two soft magnetic layers each at least 10 nm thick being alternately laminated, with the top layer and the bottom layer being the soft magnetic layers. The nonmagnetic metal layer is composed of a metal selected from Cu, Ru, Rh, Pd, Re, Os, Ir, Pt, and Au, or an alloy of these metals. The directions of magnetization in the two soft magnetic layers sandwiching the nonmagnetic metal layer are parallel to the plane of the soft magnetic layer and different from each other by 180 degrees, and the two soft magnetic layers are antiferromagnetically coupled. This structure prevents formation of magnetic domain walls when an external magnetic field is applied, thus suppressing spike noises.

### BACKGROUND

A perpendicular magnetic recording system is being contemplated over a conventional longitudinal magnetic recording system as a technique to achieve a higher density magnetic recording. In particular, a double layer perpendicular magnetic recording medium is known to be favorable for a perpendicular magnetic recording medium attainable for a higher density recording. The double layer perpendicular magnetic recording medium is provided with a soft magnetic film called a soft magnetic backing layer beneath a magnetic recording layer that carries information records. The soft magnetic backing layer facilitates to pass through magnetic flux generated by a magnetic head. In the double layer perpendicular magnetic recording medium, the intensity and gradient of the magnetic field generated by the magnetic head are enhanced, improving the recording resolution. In addition, leakage flux from such a medium is also increased. Consequently, a higher density recording is possible in the double layer perpendicular magnetic recording medium.

A perpendicular magnetic recording medium with such structure, however, has a media noise problem, including spike noises, which are known factors attributable to formation of magnetic domain walls in the soft magnetic backing layer. Therefore, to reduce noise in the perpendicular magnetic recording medium, formation of domain wall in the soft magnetic backing layer needs to be minimized or eliminated. The control of the domain wall formation in the soft magnetic backing layer is disclosed for instance in Japanese Unexamined Patent Application Publication Nos. H6-180834 and H10-214719. These references propose using a ferromagnetic layer(s) of cobalt alloy, for example, on or beneath the soft magnetic backing layer and magnetizing the ferromagnetic layer(s) in a desired direction, and forming an antiferromagnetic thin film(s) on or beneath a soft magnetic layer(s) and magnetizing the soft magnetic layer(s) in one fixed direction by taking advantage of exchange coupling between the antiferromagnetic film(s) and the soft magnetic layer(s). Here, exchange coupling between the antiferromagnetic film and the soft magnetic backing layer quite effectively inhibits formation of domain walls in the soft magnetic backing layer, as long as exchange coupling is sufficiently performed.

To obtain sufficient exchange coupling, however, heat treatment before and after deposition and complicated layer structure are typically needed in most cases, which is particularly disadvantageous in mass production. Indeed, the above-mentioned Japanese Unexamined Patent Application Publication No. H10-214719 discloses that heat treatment after deposition is necessary for sufficient exchange coupling.

Accordingly, there remains a need for a simpler approach to forming a perpendicular magnetic recording medium that can suppress spike noises. The present invention addresses this need.

### SUMMARY OF THE INVENTION

The present invention relates to a perpendicular magnetic recording medium, and in particular, to a perpendicular magnetic recording medium that can effectively suppress spike noises.

One aspect of the present invention is a perpendicular magnetic recording medium having a non magnetic substrate, and a soft magnetic backing layer, a nonmagnetic underlayer, a magnetic recording layer, and a protective film sequentially laminated on the nonmagnetic substrate.

The soft magnetic backing layer comprises at least one nonmagnetic metal layer at most 5 nm thick and at least two soft magnetic layers each at least 10 nm thick alternately laminated, with a top layer and a bottom layer of the backing layer each being one of the soft magnetic layers. Two of the soft magnetic layers sandwiching one of the nonmagnetic metal layers have magnetization directions parallel to the plane of the soft magnetic layers and different from each other by 180 degrees, i.e., magnetized in the opposite directions. The two of the soft magnetic layers are antiferromagnetically coupled. The direction of easy magnetization of the soft magnetic layers is in a plane parallel to the substrate surface and in the direction perpendicular to a running direction of a magnetic head during reading and writing.

The soft magnetic backing layer can have at least three-layered structure, including first soft magnetic layer, a nonmagnetic metal layer, and a second soft magnetic layer laminated in this order. The first soft magnetic layer and the second soft magnetic layer can have substantially equal saturation magnetic flux density and can have substantially equal thickness.

The soft magnetic backing layer can have a five-layered structure, including first soft magnetic layer, a first nonmagnetic metal layer, a second soft magnetic layer, a second nonmagnetic metal layer, and a third soft magnetic layer laminated in this order. The first soft magnetic layer, the second soft magnetic layer, and the third soft magnetic layer can have substantially equal saturation magnetic flux density, and the sum of the thickness of the first soft magnetic layer and the thickness of the third soft magnetic layer can be substantially equal to the thickness of the second soft magnetic layer.

The thickness of each of the soft magnetic layers can range from 30 nm to 150 nm.

The nonmagnetic metal layer can be composed of a metal selected from the group consisting of Cu, Ru, Rh, Pd, Re, Os, Ir, Pt, and Au, or an alloy including one or more of the metals from the group. The thickness of the nonmagnetic metal layer can range from 0.3 nm to 1.2 nm or from 1.7 nm to 3.0 nm.

### BRIEF DESCRIPTION OF DRAWINGS

FIG. 1 illustrates an example of construction of a perpendicular magnetic recording medium according to the present invention.

FIG. 2 illustrates a soft magnetic backing layer of FIG. 1 having a three layer structure.

FIG. 3 illustrates a soft magnetic backing layer of FIG. 1 having a five layer structure.

FIG. 4 shows a magnetization curve (M-H loop) of a soft magnetic backing layer with a ruthenium film thickness of 2.3 nm, measured in the direction of the disk radius by a vibrating sample magnetometer (VSM).

FIG. 5 shows Hin, an absolute value of the maximum applied magnetic field for sustaining null magnetization, as a function of thickness of the ruthenium film.

FIG. 6 shows the number of magnetic domain walls as a function of ruthenium film thickness, observed on the whole surface of a disk by means of magnetic Kerr effect.

### DETAILED DESCRIPTION

The inventors of the present invention have studied and found that fixed magnetic domain walls can be formed even after depositing an antiferromagnetic film and a soft magnetic backing layer, and conducting heat treatment. For example, when a substrate is heated to deposit a magnetic recording layer, if the temperature exceeds the blocking temperature at which an antiferromagnetic film loses the antiferromagnetic characteristic, and if an external magnetic field is not applied in an appropriate direction, the direction of magnetization in the antiferromagnetic film can change, forming a domain wall.

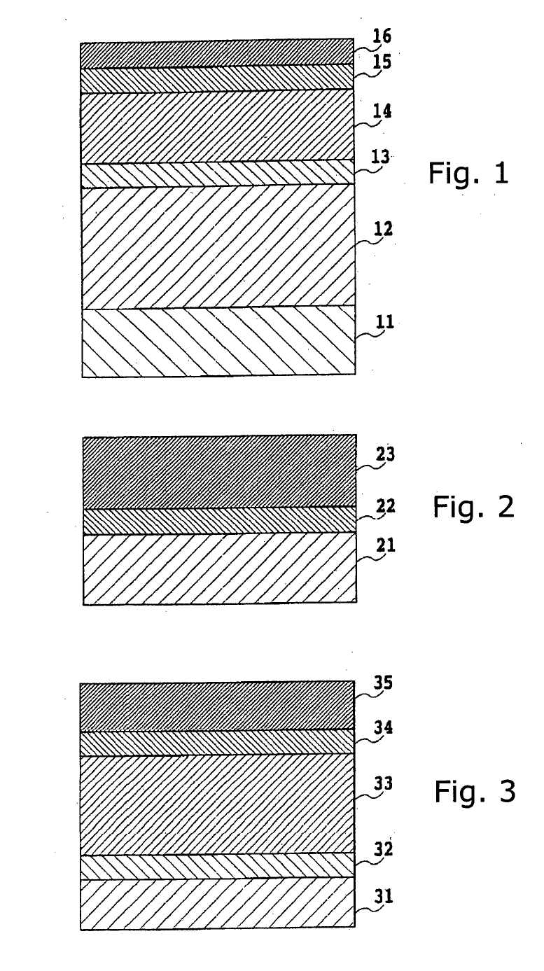

FIG. 1 illustrates an example of construction of a perpendicular magnetic recording medium according to the present invention. The perpendicular magnetic recording medium has laminated structure comprising a soft magnetic backing layer 12, a nonmagnetic underlayer 13, a magnetic recording layer 14, and a protective layer 15 sequentially formed on a nonmagnetic substrate 11. A liquid lubricant layer 16 is formed on the protective film 15.

The nonmagnetic substrate 11 can be formed of Ni—P plated aluminum alloy, strengthened glass, or crystallized glass, which are used in a common magnetic recording medium. In addition, the substrate can be made of an injection-molding plastic resin, such as polycarbonate or polyolefin.

The soft magnetic backing layer 12 has a lamination structure comprising at least one nonmagnetic metal layer at most 5 nm thick and at least two soft magnetic layers each at least 10 nm thick alternately arranged, with each of the top and bottom layers of the backing layer being one of the soft magnetic layers. A pair of soft magnetic layers sandwiching a nonmagnetic metal layer have their magnetization directions parallel to the plane of the soft magnetic layers, but different from each other by 180 degree (opposite directions), and the two soft magnetic layers are antiferromagnetically coupled.

FIG. 2 illustrates a three layer structure of the soft magnetic backing layer 12, whereas FIG. 3 illustrates a five layer structure of the same. The structure in FIG. 2 comprises a nonmagnetic metal layer 22 and a second soft magnetic layer 23 laminated on a first soft magnetic layer 21. The structure in FIG. 3 comprises a first nonmagnetic metal layer 32, a second soft magnetic layer 33, a second nonmagnetic metal layer 34, and a third soft magnetic layer 35 sequentially laminated on a first soft magnetic layer 31.

For the two soft magnetic layers sandwiching the nonmagnetic metal layer to have magnetization directions parallel to the plane of the soft magnetic layer and different from each other by 180 degrees, and for the two magnetic layers to be antiferromagnetically coupled, the nonmagnetic metal layer can be composed of a metal selected from Cu, Ru, Rh, Pd, Re, Os, Ir, Pt, and Au, or an alloy of each of these metals. Further, the thickness of the nonmagnetic metal layer can be in the range from 0.3 nm to 1.2 nm or in the range from 1.7 nm to 3.0 nm.

When a direction of easy magnetization of the soft magnetic layers is in a plane parallel to the substrate surface and in the direction perpendicular to the running direction of the magnetic head during reading or writing, that is the direction of a track, the strength and the gradient of the magnetic field generated by the magnetic head can be effectively enhanced.

It is desirable to control the direction of easy magnetization by applying magnetic field in the event of formation of the soft magnetic layer or by heat treatment accompanied by magnetic field application after the formation of the soft magnetic layer.

There is no upper limit in the number of repetitions of the alternating lamination of the soft magnetic layer and the nonmagnetic metal layer. Although the magnetization stability can be improved by increasing the number of layers, the three layer structure of FIG. 2 or the five layer structure of FIG. 3 is preferable considering productivity in mass production.

There is no special limitation on the thickness and saturation magnetic flux density of the soft magnetic layer in the three layer structure or in the five layer structure. However, to reduce the magnetostatic energy at the end regions of the nonmagnetic substrate, that is, inner and outer edge regions in the case of disk substrate, to a sufficiently low level and prevent the magnetic domain wall from forming, the soft magnetic layers 21 and 23 in the soft magnetic backing layer of three layer structure shown in FIG. 2 can have substantially equal saturation magnetic flux density and substantially equal thickness. In the soft magnetic backing layer of five layer structure shown in FIG. 3, the three soft magnetic layers 31, 33, and 35 can have substantially equal saturation magnetic flux density, and the sum of the thickness of the top and bottom soft magnetic layers 31 and 35 can be substantially equal to the thickness of the middle soft magnetic layer 33.

Concerning the thickness of each soft magnetic layer, at least 10 nm can present necessary soft magnetic performance, and 30 nm or more is desirable to sufficiently enhance intensity and sharpness of the head magnetic field. On the other hand, the thickness of no more than 150 nm is desirable because the strength of antiferromagnetic coupling lowers with the increasing thickness. The material for use in the soft magnetic layer can be selected from commonly used NiFe alloy, FeSiAl alloy, amorphous cobalt alloy, and fine particle precipitation type FeTaC alloy.

The soft magnetic backing layer as constructed above comprises at least one nonmagnetic metal layer at most 5 nm thick and at least two soft magnetic layers each at least 10 nm thick being alternately laminated, with the top and bottom layers being the soft magnetic layers. The direction of magnetization in the two soft magnetic layers sandwiching a nonmagnetic metal layer are parallel to the plane of the soft magnetic layer and different from each other by 180 degrees, and the two soft magnetic layers are antiferromagnetically coupled. Consequently, a magnetic domain wall is not formed on application of external magnetic field, providing a soft magnetic backing layer that does not generate spike noises. The magnetization in the soft magnetic layers sandwiching the nonmagnetic metal layer runs in the opposite directions, and each direction of magnetization does not change on application of external magnetic field of several tens of oersted (Oe). If more intense magnetic field is applied, when the field is removed, the magnetization in the two soft magnetic layers restores to the original state before the application of the magnetic field, which is the state where the magnetizations of the two layers are coupled in the opposite directions. Therefore, a magnetic domain wall is not produced, even in extreme conditions.

Although free magnetic poles develop and the magnetostatic energy tends to become large at the end regions of the nonmagnetic substrate in a conventional system, that is, inner and outer edge regions in the case of disk substrate, the layer structure of the present invention allows circulation of magnetic flux through the upper and lower soft magnetic layers to suppress the magnetostatic energy. Thus, formation of magnetic domain wall is inhibited even in these end regions. When the direction of easy magnetization of the soft magnetic layer is in a plane parallel to the substrate surface and in the direction perpendicular to the running direction of the magnetic head during reading and writing, that is, if the direction of easy magnetization coincides with the radial direction in the case of a nonmagnetic disk substrate, the intensity and gradient of the magnetic field generated by the magnetic head can be effectively enhanced.

The soft magnetic layers and the nonmagnetic metal layers can be formed by common methods for forming a thin film, such as a sputtering method, or a vacuum deposition method. A seed layer can be appropriately provided beneath the bottom soft magnetic layer for the purpose of improving adhesion with the substrate.

The nonmagnetic underlayer 13 is provided for the major purpose of controlling crystal alignment and grain size of the magnetic recording layer 14. Material and structure of the underlayer are selected corresponding to the material of the magnetic recording layer 14. When the magnetic layer 14 is composed of a CoCrPt alloy, for example, the material of the underlayer can be selected from Ti alloy, CoCr alloy, Pt, and Ru.

Although the thickness of the nonmagnetic underlayer is not limited to any special value, the thickness is preferably at least 5 nm for structure control of the magnetic recording layer 14 and at most 30 nm for confining the distance between the magnetic head and the soft magnetic backing layer 12 within a necessary level. The nonmagnetic underlayer 13 can also be formed of a multiple of layers that are different in material or structure for even more precise structure control of the magnetic recording layer.

The magnetic recording layer 14 can be appropriately composed of semi-hard magnetic material having the axis of easy magnetization perpendicular to the film surface. Examples of the material include CoCrPt alloy, a Co/Pt multilayered film, a TbCo amorphous film, and a composite film of two of these three kinds of films. Although the thickness of the magnetic recording layer 14 is not limited to any special value, at least 5 nm is desired to generate sufficient output in the reading head and at most 50 nm for confining the distance between the magnetic head and the soft magnetic backing layer 12 within the desired level.

The protective layer 15 can be a thin film composed of mainly carbon. The liquid lubricant layer 16 can be composed of perfluoropolyether lubricant.

Each of the nonmagnetic underlayer 13, the magnetic recording layer 14, and the protective layer 15 can be formed by any desired method for thin film formation such as a sputtering method, a CVD method, a vacuum deposition method, or a plating method.

Some examples of preferred embodiment of the invention will be described below. In a first example, a nonmagnetic substrate of a strengthened glass disk with 3.5″ diameter was used. After cleaning, the substrate was introduced into a sputtering apparatus. A soft magnetic layer 50 nm thick of Co₈₇Zr₅Nb₈, a nonmagnetic metal layer of Ru having one of the thicknesses varied in the range from 0 to 4 nm, and a soft magnetic layer 50 nm thick of Co₈₇Zr₅Nb₈, were sequentially formed by a DC magnetron sputtering method under an argon gas pressure of 5 mTorr and taken out from the apparatus to obtain a soft magnetic backing layer of three layer structure shown in FIG. 2. In the processes of depositing the soft magnetic layers, leakage magnetic flux from the target was applied in the direction of the disk radius.

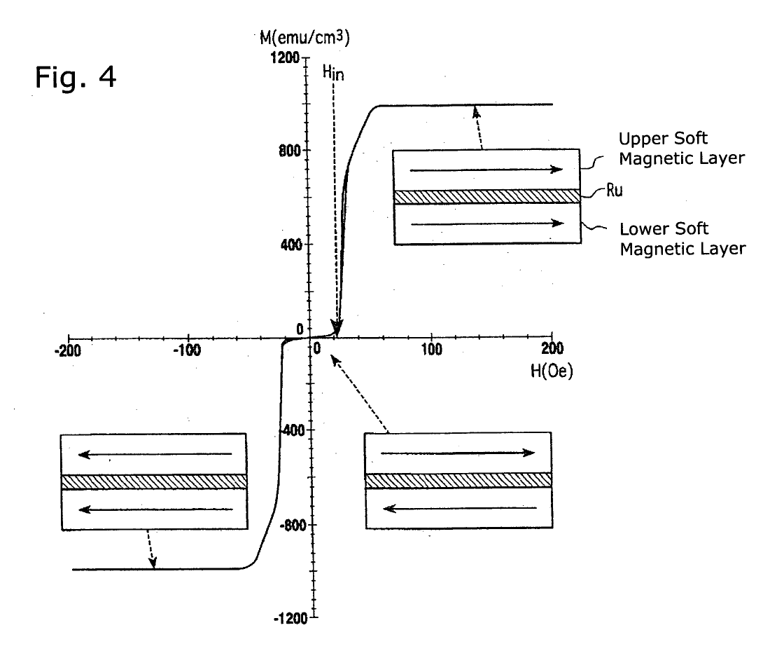

FIG. 4 shows a magnetization curve (M-H loop) of the thus formed soft magnetic backing layer with the ruthenium film having thickness of 2.3 nm in the direction of the disk radius measured by a vibrating sample magnetometer (VSM). FIG. 4 also schematically shows the direction of magnetization in the upper and lower layers.

In the regions of applied magnetic field larger than 60 Oe in positive and negative directions, the directions of magnetization in the both upper and lower soft magnetic layers are aligned in the direction of the applied magnetic field. In the region of reduced applied magnetic field of between +20 Oe and −20 Oe, the measured values of magnetization were substantially zero because the magnetization in the upper and lower soft magnetic layers couples antiferromagnetically through the ruthenium layer and aligns in the opposite directions, resulting in cancellation of the magnetization in the two layers. The region of applied magnetic field in which measured magnetization is substantially zero is a measure of strength of the coupling between the upper and lower soft magnetic layers. The measure of the coupling strength Hin is defined by an absolute value of the maximum applied magnetic field within which measured magnetization is substantially zero.

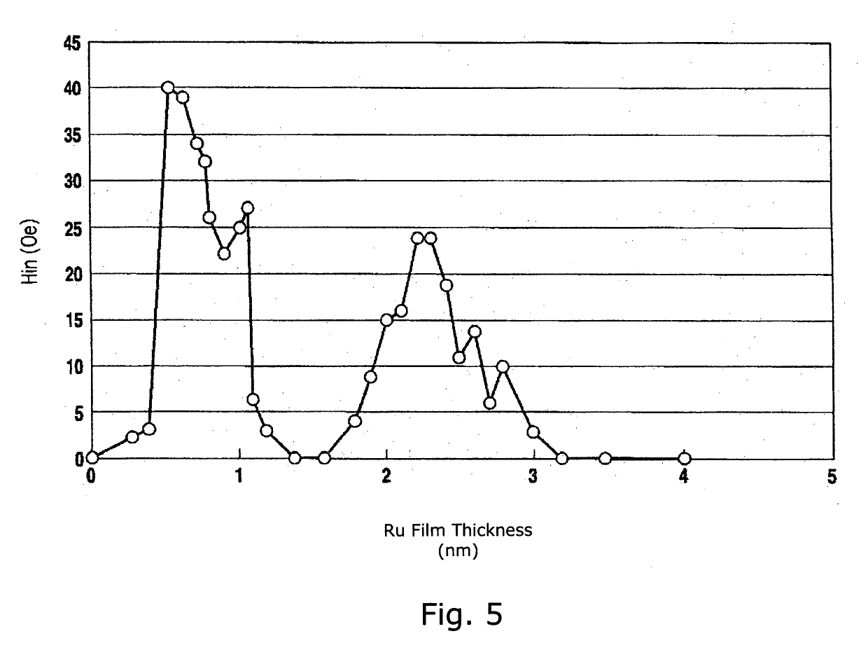

FIG. 5 shows the Hin value, an absolute value of the maximum applied magnetic field for sustaining null magnetization, as a function of thickness of the ruthenium film. When the ruthenium film thickness is zero, which means that the upper and lower soft magnetic layers are directly laminated without an intervening layer, Hin is zero, which means the magnetization in the upper and lower soft magnetic layers aligns in the same direction regardless of the magnitude of the applied magnetic field. In the regions of the ruthenium layer thickness of from 0.3 nm to 1.2 nm and from 1.7 nm to 3.0 nm, finite values of Hin were obtained indicating that the magnetization in the upper and lower soft magnetic layers aligns in the opposite directions and stabilizes in the applied magnetic field up to Hin.

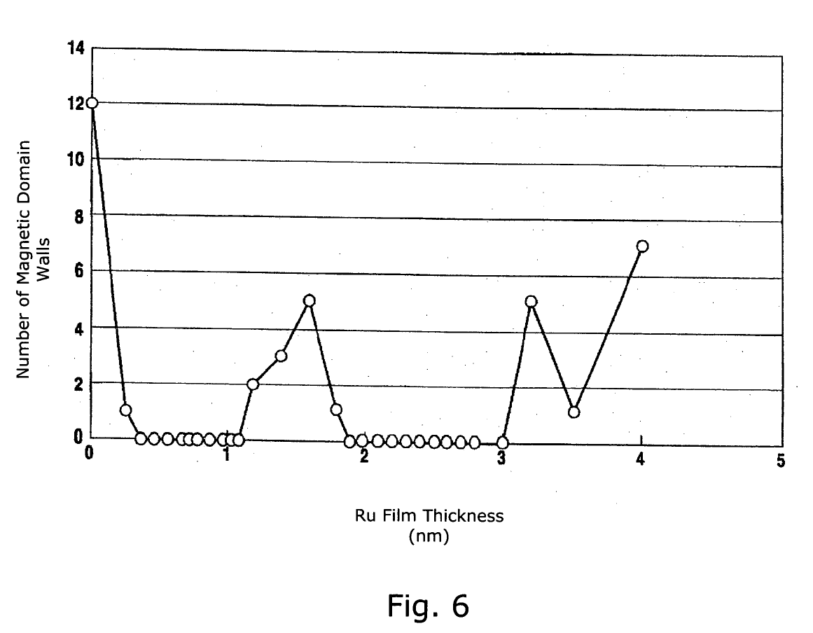

FIG. 6 shows the number of magnetic domain walls as a function of ruthenium film thickness, observed by magnetic Kerr effect on the whole surface of a disk. Generation of domain walls is inhibited in the same range of ruthenium film thickness as the range in which Hin value was finite in FIG. 5. Thus, it has been demonstrated that generation of domain walls is inhibited in a perpendicular magnetic recording medium according to the present invention.

In the second example, a series of soft magnetic backing layers having the layer structure of FIG. 2 were formed in the same manner as in the first example except that the nonmagnetic metal layers were 0.6 nm thick and composed of various materials. Table 1 summarizes a relation between the material of the nonmagnetic metal layer and the Hin value.

TABLE 1

| NONMAGNETIC | |
|---|---|
| METAL LAYER | Hin (Oe) |
| Cu | 16 |
| Ru | 39 |
| Pd | 21 |
| Re | 35 |
| Pt | 10 |
| Au | 5 |
| C | 0 |
| Ti | 0 |
| Si | 0 |

Table 1 shows that the Hin values vary depending on the material. Finite Hin values were observed for Cu, Ru, Pd, Re, Pt, and Au, while the Hin value was null for C, Ti, and Si.

As described so far, a soft magnetic backing layer in a perpendicular magnetic recording medium according to the present invention has lamination structure comprising nonmagnetic metal layers at most 5 nm thick and soft magnetic layers at least 10 nm thick being alternately laminated, with the top layer and the bottom layer being soft magnetic layers. Further, the directions of magnetization in the two soft magnetic layers sandwiching a nonmagnetic metal layer are parallel to the plane of the soft magnetic layer and different from each other by 180 degrees, and the two soft magnetic layers are antiferromagnetically coupled. Consequently, a magnetic domain wall is not formed on application of external magnetic field, providing a soft magnetic backing layer that does not generate spike noises. Therefore, a perpendicular magnetic recording medium has been provided that exhibits excellent effect to suppress generation of spike noises.

Given the disclosure of the present invention, one versed in the art would appreciate that there may be other embodiments and modifications within the scope and spirit of the present invention. Accordingly, all modifications and equivalents attainable by one versed in the art from the present disclosure within the scope and spirit of the present invention are to be included as further embodiments of the present invention. The scope of the present invention accordingly is to be defined as set forth in the appended claims.

The disclosure of the priority application, JP 2002-235777, in its entirety, including the drawings, claims, and the specification thereof, is incorporated herein by reference.

What is claimed is:

1. A perpendicular magnetic recording medium comprising:
a non magnetic substrate; and
a soft magnetic backing layer, a nonmagnetic underlayer, a magnetic recording layer, and a protective film sequentially laminated on the nonmagnetic substrate,
wherein the soft magnetic backing layer comprises at least one nonmagnetic metal layer at most 5 nm thick and at least two soft magnetic layers each at least 10 nm thick alternately laminated, with top and bottom layers of the backing layer each being one of the soft magnetic layers,
wherein two of the soft magnetic layers sandwiching one of the nonmagnetic metal layers have magnetization directions parallel to the plane of the soft magnetic layers and different from each other by 180 degrees,
wherein the two of the soft magnetic layers are antiferromagnetically coupled, and
wherein the direction of easy magnetization of the soft magnetic layers is in a plane parallel to the substrate surface and in the direction perpendicular to a running direction of a magnetic head during reading and writing.

2. A perpendicular magnetic recording medium according to claim 1, wherein the nonmagnetic metal layer is composed of a metal selected from the group consisting of Cu, Ru, Rh, Pd, Re, Os, Ir, Pt, and Au, or an alloy including one or more of the metals from the group, and the thickness of the nonmagnetic metal layer ranges from 0.3 nm to 1.2 nm or from 1.7 nm to 3.0 nm.

3. A perpendicular magnetic recording medium according to claim 1, wherein the soft magnetic backing layer is composed of at least three layers, including first soft magnetic layer, a nonmagnetic metal layer, and a second soft magnetic layer laminated in this order.

4. A perpendicular magnetic recording medium according to claim 2, wherein the soft magnetic backing layer is composed of at least three layers, including first soft magnetic layer, a nonmagnetic metal layer, and a second soft magnetic layer laminated in this order.

5. A perpendicular magnetic recording medium according to claim 3, wherein the first soft magnetic layer and the second soft magnetic layer have substantially equal saturation magnetic flux density and substantially equal thickness.

6. A perpendicular magnetic recording medium according to claim 4, wherein the first soft magnetic layer and the second soft magnetic layer have substantially equal saturation magnetic flux density and substantially equal thickness.

7. A perpendicular magnetic recording medium according to claim 1, wherein the soft magnetic backing layer is composed of five layers, including first soft magnetic layer, a first nonmagnetic metal layer, a second soft magnetic layer, a second nonmagnetic metal layer, and a third soft magnetic layer laminated in this order.

8. A perpendicular magnetic recording medium according to claim 2, wherein the soft magnetic backing layer is composed of five layers, including first soft magnetic layer, a first nonmagnetic metal layer, a second soft magnetic layer, a second nonmagnetic metal layer, and a third soft magnetic layer laminated in this order.

9. A perpendicular magnetic recording medium according to claim 7, wherein the first soft magnetic layer, the second soft magnetic layer, and the third soft magnetic layer have substantially equal saturation magnetic flux density and the sum of the thickness of the first soft magnetic layer and the thickness of the third soft magnetic layer is substantially equal to the thickness of the second soft magnetic layer.

10. A perpendicular magnetic recording medium according to claim 8, wherein the first soft magnetic layer, the second soft magnetic layer, and the third soft magnetic layer have substantially equal saturation magnetic flux density and the sum of the thickness of the first soft magnetic layer and the thickness of the third soft magnetic layer is substantially equal to the thickness of the second soft magnetic layer.

11. A perpendicular magnetic recording medium according to claim 1, wherein the thickness of each of the soft magnetic layers ranges from 30 nm to 150 nm.

12. A perpendicular magnetic recording medium according to claim 2, wherein the thickness of each of the soft magnetic layers ranges from 30 nm to 150 nm.

13. A perpendicular magnetic recording medium according to claim 3, wherein the thickness of each of the soft magnetic layers ranges from 30 nm to 150 nm.

14. A perpendicular magnetic recording medium according to claim 4, wherein the thickness of each of the soft magnetic layers ranges from 30 nm to 150 nm.

15. A perpendicular magnetic recording medium according to claim 5, wherein the thickness of each of the soft magnetic layers ranges from 30 nm to 150 nm.

16. A perpendicular magnetic recording medium according to claim 6, wherein the thickness of each of the soft magnetic layers ranges from 30 nm to 150 nm.

17. A perpendicular magnetic recording medium according to claim 7, wherein the thickness of each of the soft magnetic layers ranges from 30 nm to 150 nm.

18. A perpendicular magnetic recording medium according to claim 8, wherein the thickness of each of the soft magnetic layers ranges from 30 nm to 150 nm.

19. A perpendicular magnetic recording medium according to claim 9, wherein the thickness of each of the soft magnetic layers ranges from 30 nm to 150 nm.

20. A perpendicular magnetic recording medium according to claim 10, wherein the thickness of each of the soft magnetic layers ranges from 30 nm to 150 nm.
